(19) United States
(12) Patent Application Publication
(10) Pub. No.: US 2008/0160218 A1
(43) Pub. Date: Jul. 3, 2008

(54) IMAGING DEVICE

(76) Inventors: Shin Imamura, Kokubunji (JP); Masaaki Komatsu, Kodaira (JP); Hirotaka Sakuam, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/836,403

(22) Filed: Aug. 9, 2007

(30) Foreign Application Priority Data
Sep. 6, 2006 (JP) 2006-240940

(51) Int. Cl. C09K 11/70; B32B 9/00; C09K 19/00; H01J 1/63; H01J 29/20; H01J 17/49

(52) U.S. Cl. 428/1.1; 428/690; 313/467; 313/496; 313/584

(57) ABSTRACT

Existent imaging device involves a problem of low resolution and incapable of satisfying all of long lifetime, high luminance, and favorable color reproduction. The foregoing object can be attained according to the invention in an imaging device having excitation unit of irradiating an excitation energy to a phosphor layer to emit a light, in which at least a portion of a phosphor forming a phosphor layer contains a phosphor having a composition represented by the general formula (La_{1-x-y-z}LnₓSc_{y}M_{z})₂SiO₅ where Ln represents at least one element of Tb and Ce, M represents at least one element of Lu, Y and Gd, and x, y, and z satisfy: 0<x<1, 0<y<1, and 0<z<1.

### CLAIM OF PRIORITY

The present application claims of priority from Japanese Application JP 2006-240940 filed on Sep. 6, 2006, the content of which is herein incorporated by reference into this application.

### FIELD OF THE INVENTION

The present invention concerns a phosphor layer of high resolution, long lifetime, high luminance and good color reproduction quality suitable to image display. It further relates to an imaging device such as an electron beam excited display using the phosphor layer.

### BACKGROUND OF THE INVENTION

The imaging device in the present application means a device of exciting a phosphor by electron beam irradiation or photoirradiation, to emit light thereby displaying image information. The imaging device includes a low energy electron beam display panel (field emission display (FED), etc.), a cathode ray tube (particularly, projection tube), and a plasma display panel (PDP). Further, the imaging device also includes an entire system of displaying images using a cathode ray tube or a panel as a display part and incorporating a driving device and an image processing circuit. Further, it also includes a non-self light emitting imaging device having a light source as a back light or side light to a non-light emitting display such as liquid crystals, in addition to a self-emitting image display device as described above.

For the imaging devices, a field emitter type display (FED) is to be described mainly.

For example, a field emission display (FED) as an thin-shaped imaging device displaying color images excites a phosphor layer by electron beams accelerated at a voltage of 15 kV or lower to display images. For the low energy electron beam excited phosphor layer used in such a display, it is required that the electrical resistance is low so as to decrease a phenomenon that electrons stagnate on the surface and prevent intrusion of the electrons to the phosphor due to repulsion of electrons to each other (charge up). At present, layers using sulfide phosphors such as ZnS:Ag have been known as the phosphor layer capable of satisfying such necessary conditions. However, the sulfide phosphors tend to be decomposed due to the damage of electron beam irradiation and release a gas containing S-elements to lower the luminance of the phosphor and result in degradation of an electron source cathode. They shorten the lifetime of the display.

Particularly, since green emitting phosphor occupies 70% of luminance on a white screen, they undergo a great amount of irradiation of electron beams and improvement for the degradation of characteristics is important. As a phosphor with less decomposition and less luminance degradation, a phosphor, for example, having a component of Y₂SiO₅: Tb has been known. The phosphor has a feature in that it has less luminance saturation by excitation at a high current density and has been generally used as a practical phosphor.

For the improvement of the characteristics of the phosphor, as disclosed in JP-A No. 2(1990)-289679, the luminance and the luminance degradation are intended to be improved by mixing and calcining a compound containing at least one of Gd, Tm, Sm, and Eu as the starting material. Further, the luminance is intended to be improved as disclosed in JP-B No. 61(1986)-21505 by mixing an Mn-containing additive to the starting material and calcining them. Further, degradation is intended to be decreased as disclosed in JP-No. 2003-115481 by making an SiO₂ component excessive. Further, the luminance and the resolution are intended to be improved as disclosed in JP-A No. 2002-105450 by improving the shape of grains. Further, improvement of the luminance and decrease of the luminance degradation are intended as disclosed in JP-A No. 2004-51931 by making the grain size distribution narrower. Further, the luminance is intended to be improved as disclosed in JP-A No. 2002-105449 by adding an element such as Gd.

Further, other phosphors suffering from less decomposition and with less luminance degradation also include, for example, Y₃(Al,Ga)₅O₁₂: Tb.

However, in the phosphor layers of the related art formed with phosphors suffering from less decomposition and less luminance degradation, the emission color is tinted yellow and the color production is poor, and no good image quality can be obtained when used in an imaging device. In the phosphor layers using the existent phosphors, phosphor layers of high luminance, suffering from less decomposition, with less luminance degradation, and having good color reproduction can not be obtained.

### SUMMARY OF THE INVENTION

The existent imaging devices described above involve a problem that not all of long lifetime, high luminance, and good color reproduction can be satisfied. The present invention intends to provide an imaging device of good image quality using a phosphor layer having long lifetime, high luminance, and good color reproduction.

According to the invention, the foregoing object can be attained by an imaging device in which at least a portion of a phosphor forming a phosphor layer contains a phosphor having a composition represented by the general formula (La_{1-x-y-z}LnₓSc_{y}M_{z})₂SiO₅ where Ln represents at least one element of Tb and Ce, M represents at least one element of Lu, Y and Gd, and x, y, and z satisfy: 0<x<1, 0<y<1, and 0≦z<1.

Further, according to another aspect of the invention, the foregoing object can be attained by an imaging device in which at least a portion of a phosphor forming a phosphor layer contains a phosphor having a composition represented by the general formula (La_{1-x-y-z}LnₓM_{z})₂SiO₅ where Ln represents at least one element of Tb and Ce, M represents at least one element of Sc and Lu, and x, y, and z satisfy: 0<x<1, 0<y<1, and 0≦z<1, and the strength of the diffraction peak appearing at a position: 2θ=29° or more and 30° or less in the X-ray diffraction is ½ or less of the diffraction peak strength that appears most intensely.

Further, according to a further aspect of the invention the foregoing object can be attained by an imaging device in which at least a portion of a phosphor forming a phosphor layer contains a phosphor having a composition represented by the general formula (La_{1-x-y-x}TbₓM_{z})₂SiO₅ where Ln represents at least one element of Tb and Ce, M represents at least one element of Sc, Lu, Y and Gd, and x, and z satisfy: 0<x<1, and 0<z<1, and the strength of the diffraction peak appearing at a position: 2θ=29° or more and 30° or less in the X-ray diffraction is ½ or less of the diffraction peak strength that appears most intensely.

Further, a more preferred characteristic can be obtained by defining the ratio z of the constituent element in the chemical formula for the phosphor to a range of: 0<z<0.5.

Further, a more preferred characteristic is obtained by defining the quadrille deviation (QD) value of the grain size weight distribution of a phosphor forming the phosphor layer to a value exceeding 0.25 in the phosphor.

Further, a more preferred characteristic is obtained by defining the Si molar ratio in the chemical formula of the phosphor forming the phosphor layer based on the entire molar ratio to a range of from 0.8 to 1.2.

A more preferred characteristic of the phosphor is obtained by mixing a compound containing a constituent element other than Si with a compound containing Si and calcining them under heating.

Further, a more preferred characteristic of the phosphor is obtained by calcining under heating a compound containing all of the constituent elements simultaneously.

Further, a more preferred characteristic is obtained by defining the range for the thickness of the phosphor layer to 0.5 μm or higher and 40 m or lower in the phosphor forming the phosphor layer.

Further, a more preferred characteristic is obtained in a case where one or plural kinds of other phosphors are present in admixture in the phosphor layer.

Then, the foregoing object can be obtained by an imaging device in which an electron beam is irradiated on the phosphor layer to emit a light.

The object can be attained in a specific embodiment, by a projection tube having the phosphor layer or a projection television set including a projection tube having the phosphor layer. Further, the object can be attained by a field emission display having the phosphor layer.

Further, the object can be attained by an imaging device in which a light at a wavelength of 500 nm or less as a wavelength region where the phosphor of the invention emits light is irradiated to the phosphor layer to emit a light.

The object can be attained by a plasma display having the phosphor layer as a specific embodiment.

Further, the object can be attained by an imaging device having a light source containing the phosphor layer to at least a portion thereof.

The object can be attained in a preferred embodiment by a liquid crystal display conducting display using a light source containing the phosphor layer to at least a portion thereof.

The object can be attained according to the invention in an imaging device conducting color display by phosphor layers of three colors, that is, red light emission, blue light emission, and green light emission in which a green emitting phosphor layer of the invention is used for the phosphor layers of three colors.

A more preferred characteristic can be obtained, in an imaging device conducting color display by a phosphor layers of three colors, that is, red light emission, blue light emission, and green light emission, in which at least one portion of the red light emitting phosphor layer contains one or both of phosphors comprising Y₂O₃ or Y₂O₂S, as the ingredient and at least a portion of the blue light emitting phosphor layer contains a phosphor comprising ZnS as an ingredient, and the phosphor layer of green light emission of the invention is used.

The function of the invention is to be described below specifically.

In the phosphor of the related art, the characteristic has been improved by mixing the starting material of a Tbₓ-activated matrix Y₂₋₂ₓSiO₅ with another starting material containing, for example, Gd, Sc, Yb, Eu, Sm, Tm, Mn, Dy, and Pr and calcining them, thereby substituting a portion of the component Y.

On the contrary, in the invention, a Tbₓ-activated matrix material La₂₋₂ₓSiO₅ is used as a base, and a portion of La is substituted for Sc, Lu, Gd, and Y.

This can provide a phosphor represented by (La₁₋ₓ₋₂TbₓM_{z})₂SiO₅ in which Ln represents at least one element of Tb and Ce, M represents at least one element of Sc, Lu, Y and Gd, x and z represent numbers satisfying: 0<x<1, and 0<z<1), and having crystals different from those of the related art. It has been found that the phosphor shows a good characteristic with respect to lifetime, luminance, and color reproduction.

The phosphor of the invention comprises crystals different from those of phosphors of the related art shown in JP-A No. 2(1990)-289679, JP-B No. 61(1986)-21505, JP-B No. 06(1994)-60354, JP-A Nos. 2003-115481, 2002-105450, 2004-51931, and 2002-105449. This is shown as a feature that the strength of the diffraction peak appearing at a position: 2θ=29° or more and 30° or less in the X-ray diffraction is ½ or less of the diffraction peak strength appearing most intensely.

Further, high luminance can be obtained by providing a component where Si is identical with the stoichiometrical ratio different from the related art: JP-A No. 2003-115481.

Further, a more preferred characteristic can be obtained by conducting synthesis by mixing a compound containing substituent elements such as La, Tb, and Sc with an Si-containing compound and calcining them under heating, or calcining under heating a compound containing substituent elements such as La, Tb, and Sc and Si simultaneously.

The form of the phosphor of the invention is not particularly restricted and it may be either single crystals or polycrystals. Further, the shape may be either a sintered body or powder body. However, in a case of use for the imaging device, a powder reacted at a high temperature is preferably used. In this case, a powder with a grain size about from 1 μm to 20 μm is used.

Further, in the phosphor layer of the invention, by using in admixture with one or plural kinds of other phosphors such as Y₃(Al, Ga)₅O₁₂:Tb, Zn₂SiO₄:Mn, LaOCl:Tb, InBO₃:Tb, LaPO₄:Tb, Ce, Y₂O₃:Eu, BaMgAl₁₀O₁₇:Eu, it is possible to further increase the luminance or improve the color reproduction, or change the color or improve the lifetime characteristic.

Further, it is necessary for the phosphor layer in the related art that the thickness exceeds 40 μm in order to improve the luminance. However, by the use of the phosphor described above, a high luminance that can be served sufficiently for practical use can be obtained even with a thickness of 40 μm or less. In the invention, a high resolution and high luminance imaging device can be obtained by using the phosphor at a thickness of 40 μm or less.

An imaging device of good image quality can be provided by using an imaging device having the phosphor layer containing the phosphor of the invention as a method of use in a case for practical use.

An imaging device showing a good characteristic having long lifetime, high luminance and good color reproduction can be prepared by using the phosphor layer containing the phosphor of the invention to an imaging device using a low energy electron beam such as a field emission display (FED).

Further, an imaging device showing a good characteristic can be obtained by using the invention to a projection display. The production display comprises three projection tubes of three RBG colors. An imaging device showing a good characteristic can be prepared by using the phosphor of the invention alone, or using a mixture of a green emitting phosphor containing the phosphor of the invention as a phosphor to be coated on a face plate of a green projection tube.

Further, also in a cathode ray tube for use in a direct view type display (hereinafter simply referred to as a direct view tube), an imaging device showing a good characteristic can be prepared by using the phosphor of the invention alone or as a mixture as a green emitting phosphor in three color phosphors to be coated on a phase plate.

The invention is most suitable to an application use as a phosphor for projection tube and for FED since it has high resolution, high luminance in high current excitation and is excellent also in the luminance degradation.

Further, an imaging device showing a good characteristic can be manufactured by using the phosphor layer containing the phosphor of the invention to an imaging device conducting light emission by UV-ray excitation such as a plasma display panel (PDP).

Further, an imaging device showing a good characteristic can be manufactured by using the invention to a back light or side light source of an imaging device using liquid crystals.

The effect of the invention is not restricted by the type of the excitation source and the invention is effective for excitation sources conducting phosphor excitation of all types such as various electron beam sources or UV-ray sources.

As has been described above, the intended object can be attained in accordance with the invention. That is, the invention can provide an imaging device of high resolution and high luminance, with less degradation, and of good color reproduction.

### BRIEF DESCRIPTION OF THE DRAWINGS

FIG. 1 shows a characteristic curve of the invention showing a relation between an Sc concentration y of a phosphor and the luminance of a phosphor contained in an imaging device as an embodiment of the invention;

FIG. 2 is a graph showing the change of the X-ray diffraction peak of a phosphor by the Sc concentration y of a phosphor contained in an imaging device according to the embodiment of the invention;

FIG. 3 is a graph showing the change of the X-ray diffraction peak of a phosphor by the Sc concentration y of a phosphor contained in an imaging device as the related art;

FIG. 4 is a graph showing comparison of the X-ray diffraction peak between the phosphor according to the embodiment of the invention and that of the existent example;

FIG. 5 is a graph showing comparison of the X-ray diffraction curve between the phosphor according to the embodiment of the invention and that of the existent example;

FIG. 6 shows a characteristic curve of the invention showing a relation between a thickness, a spot diameter and a luminance of a phosphor layer contained in an imaging device according to an embodiment of the invention;

FIG. 7 is a structural view schematically showing a cross sectional view for a cathode ray tube according to an embodiment of the invention;

FIG. 8 is a structural view schematically showing a cross sectional view for a projection television imaging device according to an embodiment of the invention;

FIG. 9 is a view schematically showing a cell structure of plasma display panel according to an embodiment of the invention;

FIG. 10 is a view schematically showing the structure of plasma display panel according to an embodiment of the invention;

FIG. 11 is a view schematically showing a cell structure of a field emission display panel according to an embodiment of the invention;

FIG. 12 is a view schematically showing a cold-cathode fluorescent lamp (CCFL) used for a liquid crystal display according to an embodiment of the invention;

FIG. 13 is view schematically showing the structure of a rare gas lamp used in a liquid crystal display according to an embodiment of the invention;

FIG. 14 is view schematically showing the structure of a planer back light used in a liquid crystal display according to an embodiment of the invention; and

FIG. 15 is a view schematically showing the structure of a liquid crystal display as an exploded perspective view according to an embodiment of the invention.

### DETAILED DESCRIPTION OF THE PREFERRED EMBODIMENTS

The present invention is to be described in details with reference to the drawings.

### Embodiment 1

A phosphor layer used in an imaging device of a constitution according to the invention was manufactured by the following method and the characteristic thereof was evaluated.

The phosphor used in the invention was synthesized using, as a starting material, a compound containing Sc as a component and obtained by a method such as coprecipitation. That is, (La, Sc, Tb)₂O₃ and SiO₂ were used as the starting material. Further, as another synthesis method, identical or more excellent results were obtained also by using a compound containing all of them, that is, La, Sc, Tb, and Si and obtained by a method such as coprecipitation.

The materials were mixed each in a predetermined amount thoroughly. The mixture was placed in an alumina crucible and calcined at a temperature of 1400° C. or higher for 2 hours or more. The atmosphere upon calcining was controlled so as to provide a good characteristic. The calcined product was pulverized to obtain a phosphor powder with a grain size of about several μm.

By the method described above, phosphors having components represented by (La_{1-x-y}TbₓSc_{y})₂SiO₅ were prepared respectively by changing the components. In this case, x and y were changed within a range: 0<x≦1 , 0<y≦1.

The existent product as an object for comparison was prepared from a Tb-activated La₂SiO₅ phosphor not containing Sc with a La silicate compound being as a matrix so as to provide an optimal component.

For measuring the light emission characteristic by cathode-rays, the samples were coated by sedimentation a metal substrate to prepare phosphor layers of 40 μm thickness or less. Electron beams were irradiated at a current density within a range from 0.1 to 1000 μmA/cm² in vacuum at a vacuum degree of 10⁻⁵Pa or more to the phosphor layers and the luminance was measured. The range for the acceleration voltage was defined as from 5 to 30 kV.

The luminance was measured by a phototransistor at a position apart by 20 cm from the film surface.

FIG. 1 shows the dependence of the luminance on the Sc amount in a case of changing the Sc concentration y. In the drawing, a graph up to 0.5 was shown. The luminance of the existent example (Sc concentration y=0) was shown as 100. It can be seen that the luminance is superior to that of the existent example in a range where the Sc concentration y exceeds 0. Particularly, a sufficient improvement for the luminance was shown in a range of the Sc concentration of more than 0 and less than 0.25.

Further, FIG. 1 also shows the dependence of the CIE chromaticity parameter y in the CIE chromaticity coordinate on the Sc amount. In the green emitting phosphor, better color reproduction is shown as the value for the CIE chromaticity parameter y is larger. With a practical point of view, it is preferably 0.57 or more. From FIG. 1, the phosphor of the invention shows no remarkable change for the CIE chromaticity parameter y even when the Sc concentration is increased and shows good color reproduction for the entire component region.

Further, also in other component in a range of the activator concentration x of: 0<x≦1, same results were obtained when the Sc concentration y is changed.

Also in the component represented by (L_{1-x-y}TbₓSc_{y})₂SiO₅, an equivalent or further preferred characteristic could be obtained in a case of substituting La for at least one element of Lu, Y, and Gd.

Further, change of the emission characteristic was measured while changing where the molar amount of the contained Si based on the entire 1 mol component in the phosphor of the invention. As a result, the luminance was highest in a case where the amount of Si was 1 mol that agreed with the stoichiometrical ratio. This shows that the molar amount of Si is preferably 1.

Further, for the phosphor of the invention, the grain size distribution and the coating method were investigated. The grain size distribution of the phosphor was measured by using a coulter meter and the value for the quartile deviation (QD) value for the grain size weight distribution was used as an index for the widening of the grain size distribution. In a case of dispersing the phosphor in a paste and coating it by a printing method, a good luminance characteristic was shown when the quartile deviation (QD) value of the grain size weight distribution of the phosphor forming the phosphor layer exceeds 0.25.

Further, for the phosphor of the invention, investigation was conducted by photo-excitation. It emitted a light by photoexcitation at 500 nm or less and showed strong emission, particularly by excitation of ultraviolet light at 380 nm or less. Also in the photoexcitation, it showed better characteristic than that of existent phosphor. Particularly, a more preferred characteristic was shown by using not only Tb but also Ce as the activator as described above.

As described above, a phosphor layer of high luminance and good color reproduction can be manufactured according to the invention and, an imaging device of a good characteristic can be obtained by manufacturing the imaging device using the same.

### Embodiment 2

A phosphor layer used in an imaging device of the constitution of the invention was manufactured by the following method and the characteristic were evaluated.

The phosphor used in the invention was synthesized using, as a starting material, a compound containing Lu as a component and obtained by a method such as coprecipitation. That is, (La, Lu, Tb)₂O₃ and SiO₂ were used as the starting material. Further, as another synthesis method, identical or more excellent results were obtained as a result also by using a compound containing all of them that is, La, Lu, Tb, and Si and obtained by a method such as coprecipitation.

The materials were mixed each in a predetermined amount thoroughly. The mixture was placed in an alumina crucible and calcined at a temperature of 1400° C. or higher for 2 hours or more. The atmosphere upon calcining was controlled so as to provide a good characteristic. The calcined product was pulverized to obtain a phosphor powder with a grain size of about several pm.

By the method described above, phosphors having compositions represented by (La_{1-x-y}TbₓLu_{z})₂SiO₅ were prepared respectively by changing the components. In this case, x and z were changed within a range: 0<x≦, 0<z≦1.

The existent product as an object for comparison was prepared from a Tb-activated La₂SiO₅ phosphor not containing Lu with a La silicate compound as a matrix so as to provide an optimal components.

For measuring the light emission characteristic by the cathode-rays, the samples were coated by sedimentation on a metal substrate to prepare phosphor layers of 40 μm thickness or less. Electron beams were irradiated at a current density within a range from 0.1 to 1000 μmA/cm² in vacuum at a vacuum degree of 10⁻⁵Pa or more to the phosphor layers and the luminance was measured. The range for the acceleration voltage was from 5 to 30 kV.

The luminance was measured by a phototransistor at a position apart by 20 cm from the film surface.

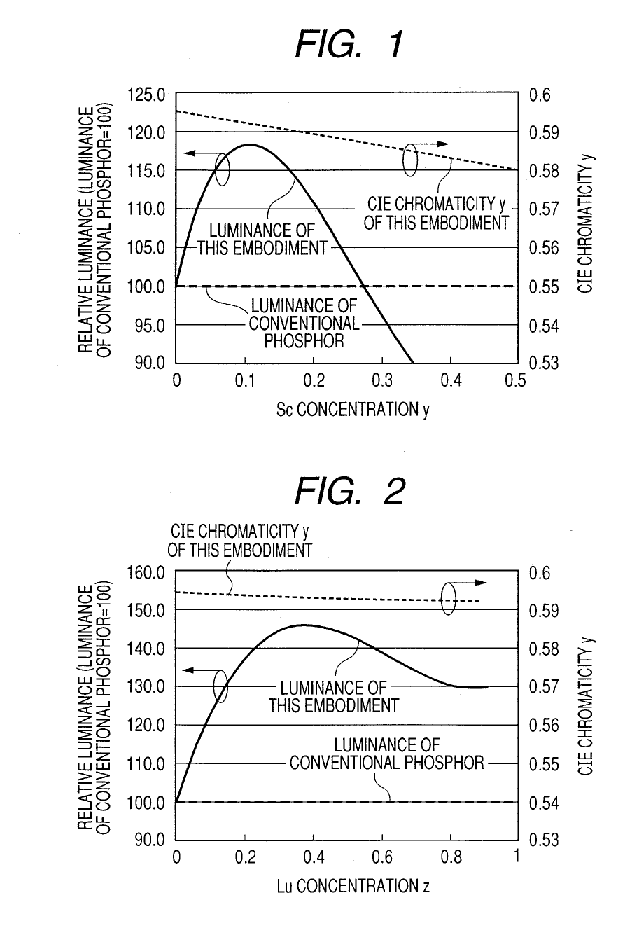

FIG. 2 shows the dependence of the luminance on the Lu amount in a case of changing the Lu concentration z. The luminance of the existent example (Lu concentration z=0) was shown as 100. It can be seen that the luminance is superior to that of the existent example in a range where Lu concentration z exceeds 0, particularly, a sufficient improvement for the luminance was shown in a range of the Lu concentration of more than 0 and less than 0.5.

Further, FIG. 2 also shows the dependency of the CIE chromaticity parameter y in the CIE chromaticity coordinate on the Lu amount. In the green emitting phosphor, a more preferred color reproduction is shown as the value for the CIE chromaticity parameter y is larger. With a practical point of view, it is preferably 0.57 or more. From FIG. 2, the phosphor of the invention shows no remarkable change for the CIE chromaticity parameter y even when the Lu concentration increases and shows good color reproduction for the entire compositional region.

Further, also in other components in a range of the activator concentration x of : 0<x≦1, same results were obtained when the Lu concentration y is changed.

In the component represented by (L_{1-x-y}TbₓLu_{z})₂SiO₅, equivalent or further preferred characteristic could be obtained in a case of substituting La for at least one element of Sc, Y, Gd.

Further, change of the emission characteristic was measured while changing where the molar amount of the contained Si based on the entire 1 mol component in the phosphor of the invention. As a result, the luminance was highest in a case where the amount of Si was 1 mol that agreed with the stoichiometrical ratio. This shows that the molar amount of Si is preferably 1.

Further, for the phosphor of the invention, the grain size distribution and the coating method were investigated. The grain size distribution of the phosphor was measured by using a coulter meter and the value for the quartile deviation (QD) value for the grain size weight distribution was used as an index for the widening of the grain size distribution. In a case of dispersing the phosphor in a paste and coating it by a printing method, a good luminance characteristic was shown when the quartile deviation (QD) value of the grain size weight distribution of the phosphor forming the phosphor layer exceeds 0.25.

Further, for the phosphor of the invention, investigation was conducted by photo-excitation. It emitted a light by photoexcitation at 500 nm or less and showed strong emission, particularly by excitation of ultraviolet light at 380 nm or less. Also in the photo-excitation, it showed better characteristic than that of existent phosphors. Particularly, a more preferred characteristic was shown by using not only Tb but also Ce as the activator as described above.

As described above, a phosphor layer of high luminance and good color reproduction can be manufactured according to the invention and an imaging device of good characteristic can be obtained by manufacturing the imaging device using the same.

### Embodiment 3

A phosphor layer used in an imaging device of the constitution of the invention was manufactured by the following method and the characteristic were evaluated.

The phosphor used in the invention was synthesized using, as a starting material, a compound containing Lu as a component and obtained by a method such as coprecipitation. That is, (La, Y, Tb)₂O₃ and SiO₂ were used as the starting material. Further, as another synthesis method, identical or more excellent results were obtained as a result also by using a compound containing all of them that is, La, Y, Tb, and Si and obtained by a method such as coprecipitation.

The materials were mixed each in a predetermined amount thoroughly. The mixture was placed in an alumina crucible and calcined at a temperature of 1400° C. or higher for 2 hours or more. The atmosphere upon calcining was controlled so as to provide a good characteristic. The calcined product was pulverized to obtain a phosphor powder with a grain size of about several μm.

By the method described above, phosphors having compositions represented by (La_{1-x-y}TbₓY_{z})₂SiO₅ were prepared respectively by changing the components. In this case, x and z were changed within a range: 0<x<1, 0<z≦1.

The existent product as an object for comparison was prepared from a Tb-activated La₂SiO₅ phosphor not containing Y with a La silicate compound as a matrix so as to provide an optimal components.

For measuring the light emission characteristic by the cathode-rays, the samples were coated by sedimentation on a metal substrate to prepare phosphor layers of 40 μm thickness or less. Electron beams were irradiated at a current density within a range from 0.1 to 1000 μmA/cm² in vacuum at a vacuum degree of 10⁻⁵Pa or more to the phosphor layers and the luminance was measured. The range for the acceleration voltage was from 5 to 30 kV.

The luminance was measured by a phototransistor at a position apart by 20 cm from the film surface.

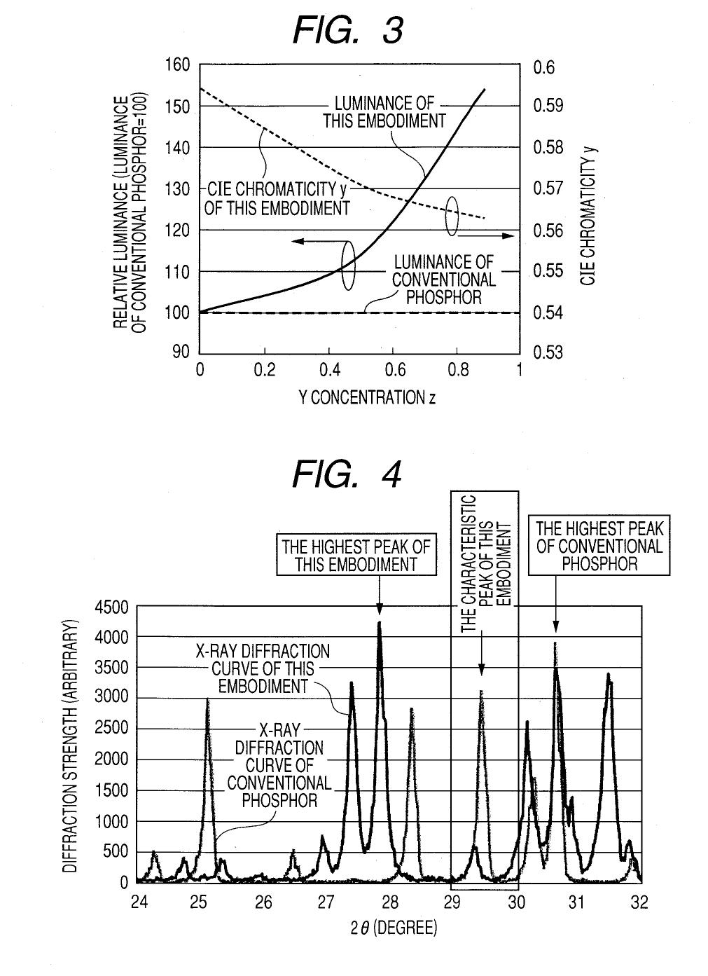

FIG. 3 shows the dependence of the luminance on the Y amount in a case of changing the Y concentration z. The luminance of the existent example (Y concentration z=0) was shown as 100. It can be seen that the luminance is superior to that of the existent example in a range where the Y concentration z exceeds 0. As the Y concentration was higher, the luminance was improved more.

Further, FIG. 3 also shows the dependency of CIE chromaticity parameter y in the CIE chromaticity coordinate on the Lu amount. In the green emitting phosphor, a more preferred color reproduction is shown as the value for the CIE chromaticity parameter y is larger. With a practical point of view, it is preferably 0.57 or more. In view of FIG. 3, in the phosphor of the invention, the CIE chromaticity parameter y was lowered greatly as the Y concentration is increased. A preferred range for the CIE chromaticity is within a range where the Y concentration is 0.5 or less.

Further, also in other components in a range of the activator concentration x of: 0<x≦1, same results were obtained when the Y concentration y is changed.

In the composition represented by (L_{1-x-y}TbₓY_{z})₂SiO₅, equivalent or further preferred characteristic could be obtained in a case of substituting La for at least one element of Sc, Lu, and Gd.

Further, change of the emission characteristic where the molar amount of contained Si based on the entire 1 mol components was changed to measure the change of the light emission characteristic in the phosphor of the invention. As a result, the luminance was highest for 1 molar amount of Si that agreed with the stoichiometrical ratio. This shows that the molar amount of Si is preferably 1.

Further, for the phosphor of the invention, the grain size distribution and the coating method were investigated. The grain size distribution of the phosphor was measured by using a coulter meter and the value for the quartile deviation (QD) value for the grain size weight distribution was used as an index for the widening of the grain size distribution. In a case of dispersing the phosphor in a paste and coating it by a printing method, a good luminance characteristic was shown when the quartile deviation (QD) value of the grain size weight distribution of the phosphor forming the phosphor layer exceeds 0.25.

Further, for the phosphor of the invention, investigation was conducted by photo-excitation. It emitted a light by photoexcitation at 500 nm or less and showed strong emission, particularly, by excitation of ultraviolet light at 380 nm or less. Also in the photo-excitation, it showed better characteristic than that of existent phosphors. Particularly, a further preferred characteristic was shown by using not only Tb but also Ce as the activators described above.

As described above, a phosphor layer of high luminance and good color reproduction can be manufactured according to the invention and an imaging device of a good characteristic can be obtained, by manufacturing the imaging device using the same.

### Embodiment 4

For the phosphor used in the imaging device of the constitution of the invention, difference of crystals with those of the existent example was evaluated.

The phosphor of the invention was manufactured in the same manner as in Example 1 and phosphors having the components represented by (La_{1-x-y-z}TbₓSc_{y})₂SiO₅ were manufactured respectively. In this case, x and y were changed in a range: 0<x≦1, 0<y≦1.

The existent product as an object for comparison was prepared from a Tb-activated Y₂SiO₅ phosphor not containing Sc with a Y silicate compound as a matrix so as to provide an optimal components.

X-ray evaluation was conducted by using a diffraction curve by kα characteristic line of Cu and a powder X-ray diffraction apparatus, and a measured value by θ-2θ scanning was used.

FIG. 4 shows a graph for X-ray diffraction strength near the strongest peak in the X-ray diffraction for the phosphor of the invention. It can be seen that the invention shows a different diffraction pattern of crystals different from those of the existent example and new crystals are formed. For example, the highest peak of the embodiment is often present in a range of: 2θ=27 to 28°, whereas this is present in the existent embodiment in a range from 30 to 31°.

As the feature of the crystals of the phosphor of the invention, the strength of the peak in a range of: 2θ=29 to 30° can be mentioned. In the invention, the strength of the peak in this range is ½ or less to the highest peak. On the contrary, in the existent embodiment, the strength of the peak in the range is about 80% to the highest peak. The crystals of the invention different from those of the existent embodiment can be characterized by the strength of the peak present in the range.

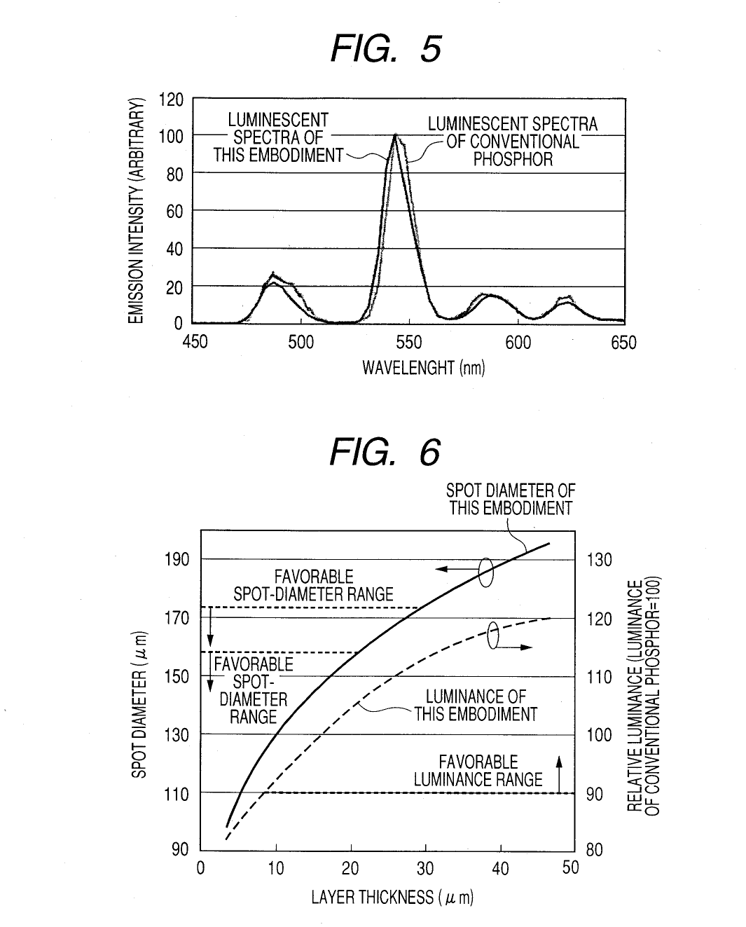

FIG. 5 shows comparison of luminance spectra by the ultraviolet excitation between the embodiment of the invention and the existent embodiment. Comparing the green emitting peak near 540 nm, the peak of the embodiment of the invention situates on the shorter wavelength side than that of the existent embodiment. This is a direction where the green light emission approaches a pure color. Further, when compared with the blue emitting peak at 480 nm, the peak strength of the embodiment of the invention is smaller than that of the existent example. This is as direction where the emission other than the green light emission decreases.

By the difference described above, the color reproduction of green light emission is more preferred in the invention than in the existent embodiment. The difference in the luminescent spectra is mainly attributable to that the crystals of the phosphor of the invention are different from those of the existent embodiment described above.

As described above, a phosphor layer of good color reproduction can be manufactured according to the invention and, an imaging device of a good characteristic can be obtained by manufacturing the imaging device using the phosphor layer.

### Embodiment 5

The imaging device with the constitution of the invention was manufactured while changing the thickness of the phosphor layer and characteristic was evaluated.

Phosphor layers used in the imaging device of the invention according to the phosphor containing Sc shown in Embodiment 1 were manufactured while changing the film thickness in a range from 5 to 50 μm. Electron beams were irradiated to the phosphors and the luminance was measured in accordance with the measuring method of the Embodiment 1. Further, the spot diameter as an index of the resolution was measured.

The spot diameter is a diameter for the brightening point when an electron beam is irradiated to one point. Usually, it is measured while scanning the electron beams. The light emission point moving by scanning is decomposed in the moving direction by a slit to measure the change with time of the emission intensity. From the result, change of the emission intensity due to the position in the light emission point was calculated. In this case, the position where the emission intensity reduces to 10% relative to the maximum light emission intensity (center for the emission point) was assumed as the light emission point and the distance between the positions at 10% was defined as a spot diameter.

The spot diameter is concerned with the size of a pixel on the screen and the resolution of images is lost unless the diameter is reduced to a certain size or less. A preferred spot diameter is 200 μm or less and, more preferably, about 170 to 180 μm or less. Further, for sufficiently opening with high resolution images such as of high vision, it is preferably about 150 to 160 μm or less.

The thickness of the phosphor was measured for the thickness of the cross section of the phosphor layer by using a scanning electron microscope. Further, the thickness for the phosphor layer from a substrate or a face panel was also measured by using a non-contact step meter. In view of the result described above, a reasonable value was defined as a thickness of the phosphor layer.

FIG. 6 shows the change of the spot diameter and the relative luminance to the thickness of the phosphor layer in the invention. It can be seen that the spot diameter decreases as the thickness of the layer is reduced. In view of the graph, it can be seen that the film thickness for obtaining the spot diameter described above is 40 μm or less, preferably, 30 μm or less and, more preferably, less than 21 μm.

Further, it can be seen from FIG. 6 that the relative luminance lowers as the film thickness is reduced. While the relative luminance of existent phosphor is assumed as 100, the relative luminance of 80 or more is favorable for practical use. Further, it is preferred that the relative luminance is 90 or more. In view of the graph, it can be seen that the film thickness is 10 μm or more for obtaining relative luminance of 90 or more.

As described above, a phosphor layer of high resolution can be manufactured according to the invention, and an imaging device of high resolution and high luminance can be obtained by manufacturing an imaging device by using the phosphor layer.

### Embodiment 6

As a green emitting phosphor layer conducting imaging display, a projection tube for use in green images of 18 cm diagonal size having a phosphor layer with the phosphor of the invention was manufactured.

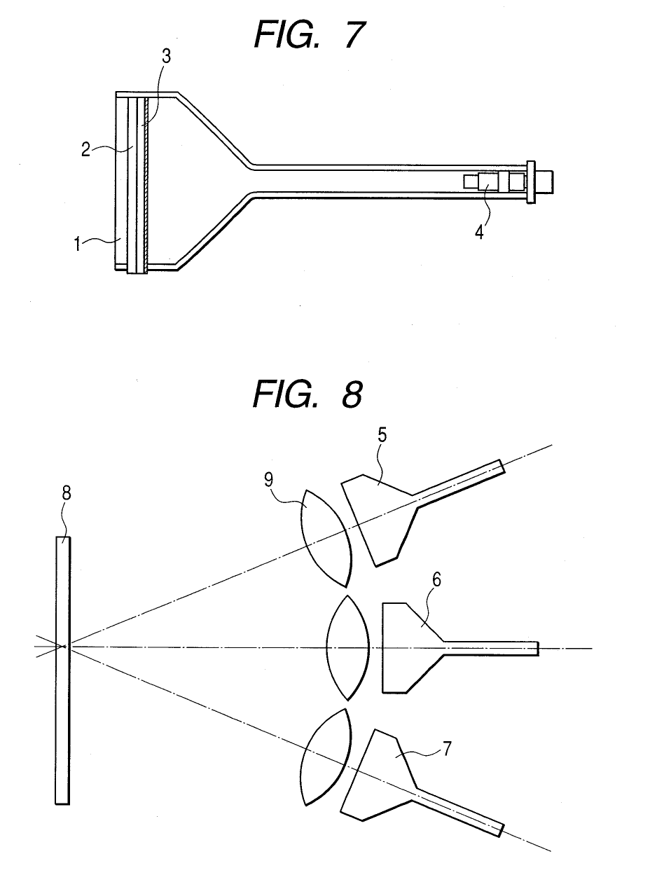

FIG. 7 shows a conceptional view for the cross section of a projection tube. In the drawing, the projection tube has an electron beam gun 4 at the end of a neck and has a phosphor layer 2 and a metal back 3 at the inner surface of a face plate 1. The phosphor layer of the projection tube is constituted with a mono-color layer. The phosphor layer 2 was formed by sedimentation in a 7 inch bulb using the means of the invention, filming, aluminum pack vapor deposition were conducted, parts such as an electron beam gun were attached and evacuation and sealing were conducted to complete the cathode ray tube.

Using the cathode ray tubes of the invention, excitation was conducted by cathode rays at 0.1 to 10 mA under application of 30 kV voltage and irradiated at a size of 102×76 mm by TV scanning. The emission characteristic was measured by the method shown below.

The luminance was measured by using a luminance meter at a position apart by several tens cm. Further, the spot diameter was measured by a method according to Embodiment 2.

As a result of the evaluations, the cathode ray tubes manufactured in this case were superior to existent tubes in view of there solution. In addition, they were identical with or superior to existent tubes also in the luminance characteristic. That is, an imaging device of good image quality having high resolution and high luminance was obtained according to the invention.

### Embodiment 7

A projection television imaging device having a phosphor layer with the phosphor of the invention as the green emitting phosphor layer for conducting image display was manufactured.

As shown in Embodiment 6, a projection tube for green images of a 18 cm diagonal size according to the invention was manufactured. Further, in combination with other projection tube for blue image and a projection tube for red image, a projection television imaging device was manufactured.

FIG. 8 shows a schematic view of a projection television imaging device according to the invention. In the drawing, a cathode ray tube 5 for red image, a cathode ray tube 6 for green image of the invention, a cathode ray tube 7 for blue image are shown, and a projection screen 8 was located opposing to them at a position apart by a predetermined distance. Further, a projection lens system 9 is arranged to each of the projection tubes with each central axis by which mono-color images are projected on the projection screen 8 while being condensed and enlarged to the face plate of each of the projection tubes to obtain color images where three colors are superimposed and synthesized.

Actually, the projection television imaging device comprises, in addition to each of the cathode ray tubes for images, the projection screen and the projection lens system, imaging devices such as a television tuner, a cathode ray tube driving circuit, an image signal processing circuit, as well as audio devices such as audio speakers and amplifiers, and operation devices such as switches or variable registers, and an outer casing for housing the entire system, a supporting frame, or a base.

In this embodiment, the emission characteristic was measured by each of the methods shown below. The luminance was measured by a luminance meter at a luminance position apart by several tens cm and the of the current standard product used so far was expressed by a relative luminance being assumed as 100. In the measurement, excitation was conducted by cathode rays at 0.1 to 10 mA under application of 30 kV voltage and irradiated at a size of 102×76 mm by TV scanning.

The emission color of the phosphor was measured by using a chromaticity meter at a position apart by several tens cm. The emission color was compared with the CIE chromaticity parameter y on the x-y CIE chromaticity coordinate.

For the measurement of the luminance degradation characteristic, cathode rays at about 0.5 mA irradiated at a size of 102×76 mm was irradiated continuously for 1000 hours and the characteristic was compared with the luminance ratio before and after the irradiation.

Further, high resolution images such as of high vision were displayed and resolution was evaluated specifically.

As a result of the evaluation, the projection television imaging device manufactured in this case was superior to the existent devices in view of there resolution. Further, it was equivalent or superior to the existent devices also in the luminance and the luminance degradation characteristic. That is, an imaging device of good image quality having long lifetime, and high resolution and high luminance was obtained according to the invention.

### Embodiment 8

As a green phosphor layer for conducting image display, a projection television imaging device having the phosphor layer with the phosphor of the invention was manufactured.

As shown in Embodiment 6, a projection tube for green image of a 18 cm diagonal size according to the invention was manufactured. Further, a cathode ray tube with the phosphor layer containing ZnS:Ag, Al phosphor was used as another projection tube for blue image. Further, a cathode ray tube with the phosphor layer containing a Y₂O₃:Eu was used as the projection tube for red image. The projection television imaging device was manufactured by combining them.

The same evaluation was conducted by the same constitution as in Embodiment 7.

As a result of the evaluations, the projection television imaging devices manufactured in this case was superior to the existent device in the resolution. Further, also in the luminance and the luminance degradation characteristic, it was equivalent with or superior to the existent device. A particularly favorable result was obtained in view of tone or image quality in the evaluation for three colors together. That is, an imaging device of favorable image quality having long lifetime and high resolution and high luminance was obtained according to the invention.

Further, same results were obtained also in a case of using a cathode ray tube with a phosphor layer other than that described above containing the phosphor comprising ZnS as an ingredient as a projection tube for blue image. Further, same effects were obtained also in a case of using a cathode ray tube with a phosphor layer other than that described above containing one or both of the phosphors comprising Y₂O₃ or Y₂O₂S as an ingredient in at least a portion thereof. An imaging device of favorable image quality was obtained by combining them.

### Embodiment 9

A projection tube for green image of 18 diagonal size was manufactured by using a phosphor layer of the invention in which Zn₂SiO₄:Mn phosphor was present in admixture as the green phosphor layer for conducting image display. Further, a projection television imaging device was manufactured by combining the projection tube for green image using the technique of the invention with other projection tube for blue image and a projection tube for red image. The constitution and the measuring method for the characteristic of the device are identical with those in Embodiment 7.

The CIE chromaticity parameter y and the relative luminance in the CIE chromaticity coordinate were measured while varying the weight ratio of the Zn₂SiO₄:Mn phosphor to the entire portion from 0 to 1 in the mixed layer. In the green phosphor, the color reproduction was more preferred as the CIE chromaticity parameter y is larger to obtain favorable images. It can be seen that as the weight ratio of the Zn₂SiO₄:Mn phosphor was increased the CIE chromaticity parameter y increases to show favorable color reproduction. On the other hand, the luminance lowers as the weight ratio of the Zn₂SiO₄:Mn phosphor increases. In view of the color reproduction, a greater weight ratio is preferred for the Zn₂SiO₄:Mn, but the weight ratio is preferably 0.4 or less in order to obtain a luminance for practical use. By using the mixed phosphors within the range, an imaging device having a favorable characteristic can be provided.

Further, a cathode ray tube was manufactured by mixing other phosphors different in the chromaticity of light emission from that of the invention such as an LaOCl:Tb phosphor or InBO₃:Tb phosphor instead of the Zn₂SiO₄:Mn phosphor with the phosphor of the invention. As a result, same effects as described above were obtained.

### Embodiment 10

A projection tube for green image of 18 diagonal size was manufactured by using a phosphor layer of the invention in which a Y₃(Al,Ga)₅O₁₂:Tb phosphor was present in admixture as the green phosphor layer for conducting image display. Further, a projection television imaging device was manufactured by combining the projection tube for green image using the technique of the invention with other projection tube for blue image and projection tube for red image. The constitution and the method of measuring the characteristic for the device are identical with those in Embodiment 7.

In the mixed layer, the weight ratio of the Y₃(Al,Ga)₅O₁₂:Tb phosphor to the entire portion was changed from 0 to 1, and the CIE chromaticity parameter y, the relative luminance and the luminance degradation characteristic were measured. This provided the result that the relative luminance and the luminance degradation characteristic were improved but the CIE chromaticity parameter y was lowered as the weight ratio of the Y₃(Al,Ga)₅O₁₂:Tb phosphor was increased. The CIE chromaticity parameter that can be served for the practical use could be obtained at a weight ratio of the Y₃ (Al, Ga) ₅O₁₂: Tb phosphor of 0.6 or less. By using the mixed phosphor within the range described above, an imaging device having high luminance with less luminance degradation and favorable characteristic can be provided.

Further, instead of Y₃(Al,Ga)₅O₁₂:Tb phosphor, a cathode ray tube was manufactured by mixing other phosphors different from the luminance and the degradation characteristic from those of the invention with the phosphor of the invention. As a result, effects as described above were obtained.

### Embodiment 11

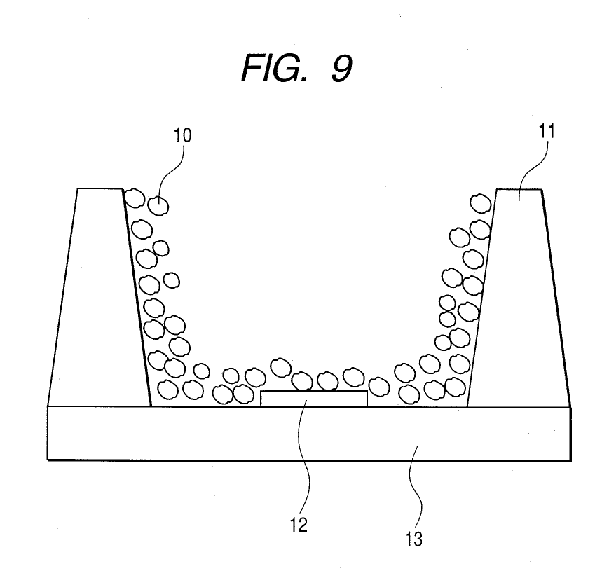

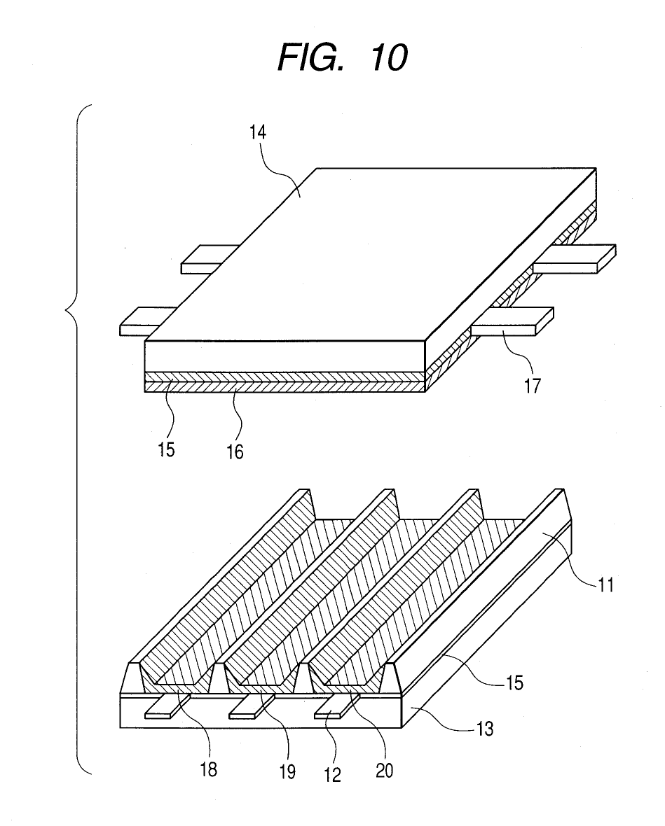

The phosphor layer of the constitution of the invention was applied to a plasma display panel (PDP). FIG. 9 shows a cell structure of the plasma display panel. Further, FIG. 10 shows the constitution of the plasma display panel. A plasma display panel of the invention having such a structure was manufactured.

As a result of evaluating the characteristic, the plasma display panel according to the invention manufactured in this case was superior in view of the lifetime and the luminance to the existent display. In addition, it was equivalent with or superior to the existent display also in the color reproduction. That is, an imaging device of favorable characteristic was obtained according to the invention.

### Embodiment 12

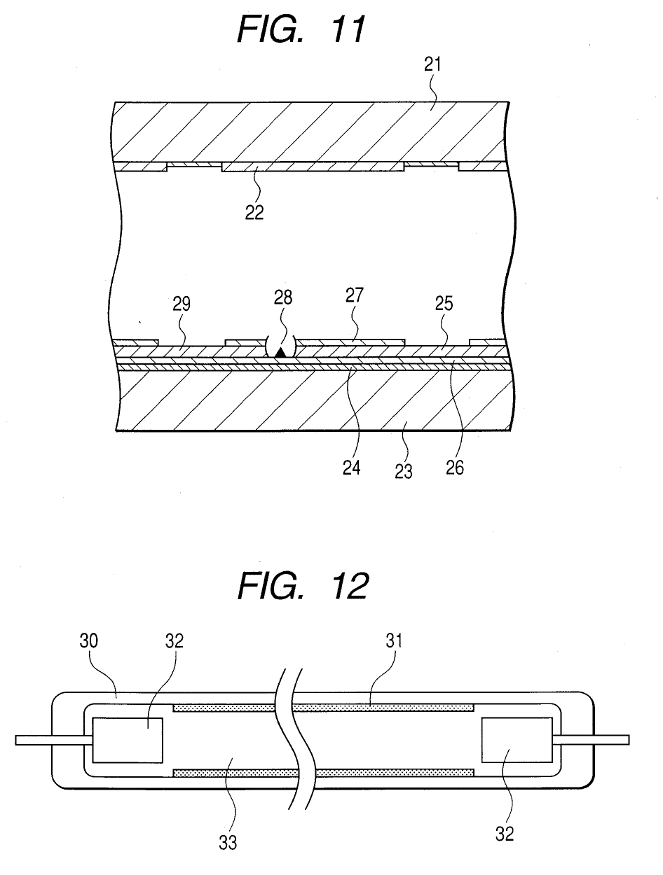

The phosphor layer of the constitution of the invention was applied to a field emission display (FED) for exciting by a low energy electron beams. FIG. 11 shows the cell structure of the field emission display. The field emission display according to the invention of such a structure was manufactured.

As a result of evaluating the characteristic, the field emission display according to the invention manufactured in this case was superior in view of the lifetime and the luminance to the existent display. In addition, it was equivalent with or superior to the existent display also in the color reproduction. That is, an imaging device of favorable characteristic was obtained according to the invention.

Further, while an example using an electron beam source referred to as a Spindt-type is shown in this embodiment, the present invention is effective also to all types of electron beam sources such as a metal-insulator-metal (MIM) type electron beam source or an electron beam source using carbon nanotubes (CNT).

### Embodiment 13

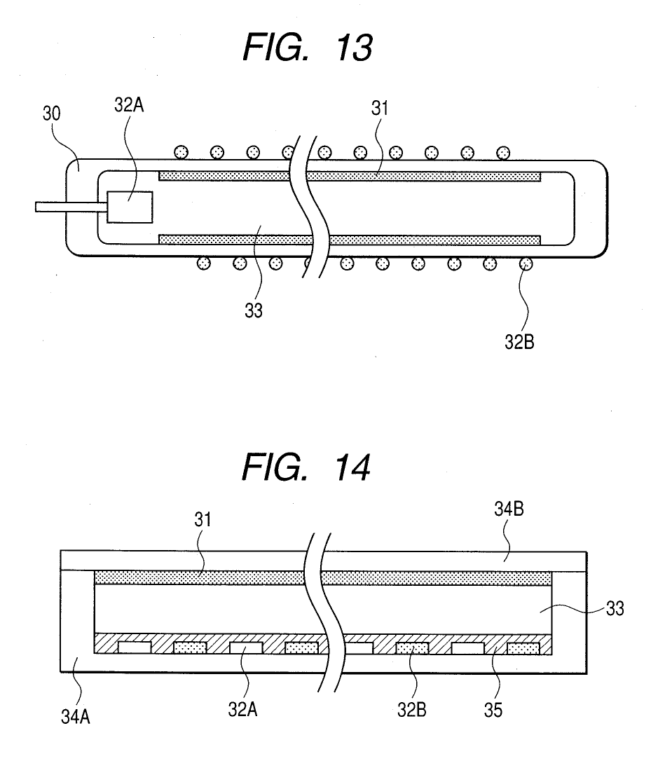

FIG. 12 shows a schematic view for the structure of a cold cathode fluorescent lamp (CCFL) using a back light in which the phosphor layer of the constitution of the invention is applied to a back light of a liquid crystal display. Further, FIG. 13 shows a schematic structure of a rare gas (xenon) lamp using as a back light of other constitution in the invention. Further, FIG. 14 shows a schematic view of a structure of a plane (xenon) lamp used as a back light of other constitution in the invention.

The phosphor layer of the invention was used as a phosphor layer of the back lights. White light emission was obtained by using the Y₂O₃:Eu phosphor and the BaMgAl₁₀O₁₇:Eu phosphor together as the phosphor layer. Further, a phosphor layer in which one or both of the phosphor layers of the LaPO₄:Tb, Ce phosphor and a phosphor generally referred to as SCA:Eu, and one or both of the phosphors described above are mixed together or mixed separately was also manufactured.

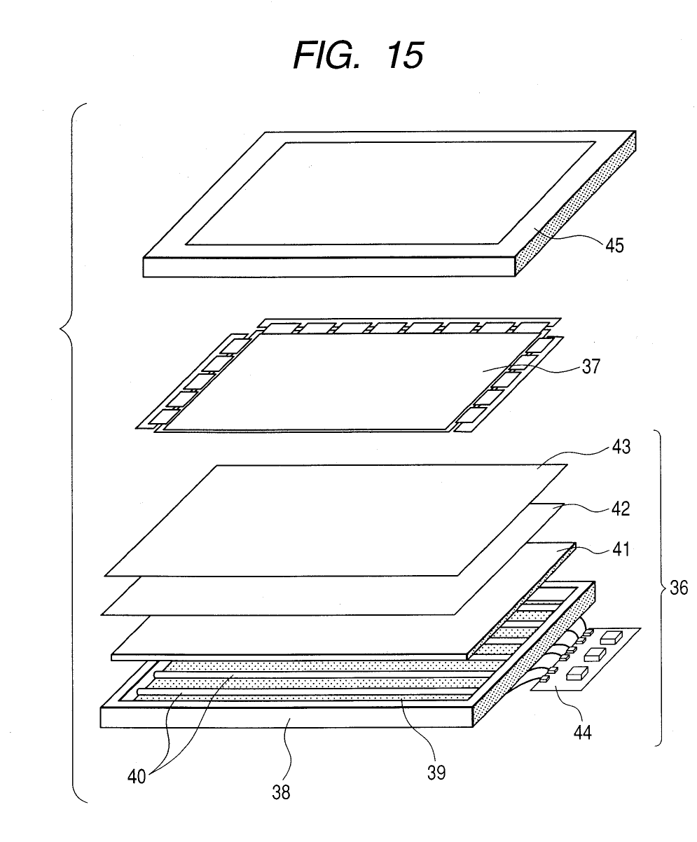

A liquid crystal display was manufactured by using the back lights described above. FIG. 15 shows a drawing schematically showing the structure of a liquid crystal display in a case of using a cold cathode tube as an exploded perspective view.

As a result of evaluating the characteristic, the liquid crystal display according to the invention manufactured in this case was superior in view of the luminance to the existent display. In addition, it was equivalent with or superior to the existent display also in the color reproduction. That is, an imaging device of high luminance and favorable image quality was obtained according to the invention.

Further, according to the constitution of the invention, a sufficient effect can be obtained by using the light source not restricted only to the type illustrated herein but also with those of other types. For example, the present invention can provide an effect, particularly, in a hot cathode fluorescent lamp (HCFL). Further, a sufficient effect can also be obtained when it is used not only to the back light but also as a light source for a side light or a front projection.

According to the invention, a liquid crystal display of good image quality having higher luminance than that of the existent display can be manufactured.

What is claimed is:

1. An imaging device having excitation unit for irradiating an excitation energy to a phosphor layer to emit a light, in which at least a portion of a phosphor forming a phosphor layer contains a phosphor having a composition represented by the general formula (La_{1-x-y-z}LnₓSc_{y}M_{z})₂SiO₅ where Ln represents at least one element of Tb and Ce, M represents at least one element of Lu, Y and Gd, and x, y, and z satisfy: 0<x<1, 0<y<1, and 0≦z<1.

2. An imaging device having excitation unit for irradiating an excitation energy to a phosphor layer to emit a light in which at least a portion of a phosphor forming a phosphor layer contains a phosphor having a composition represented by the general formula (La_{1-x-y-z}LnₓM_{z})₂SiO₅ where Ln represents at least one element of Tb and Ce, M represents at least one element of Sc and Lu, and x and z satisfy: 0<x<1 and 0<z<1, and the strength of the diffraction peak appearing at a position: 2θ=29° or more and 30° or less in the X-ray diffraction is ½ or less of the diffraction peak strength that appears most intensely.

3. An imaging device having excitation unit for irradiating an excitation energy to a phosphor layer to emit a light in which at least a portion of a phosphor forming a phosphor layer contains a phosphor having a composition represented by the general formula (La_{1-x-y-z}LₓM_{z})₂SiO₅ where Ln represents at least one element of Tb and Ce, M represents at least one element of Sc, Lu, Y, and Gd and x and z satisfy: 0<x<1 and 0<z<1, and the strength of the diffraction peak appearing at a position: 2θ=29° or more and 30° or less in the X-ray diffraction is ½ or less of the diffraction peak strength that appears most intensely.

4. An imaging device according to claim 1, wherein the ratio y of the constituent element in the chemical formula of the phosphor is: 0<y<0.25.

5. An imaging device according to claim 1, wherein the ratio z of the constituent element in the chemical formula of the phosphor is: 0<z<0.5.

6. An imaging device according to claim 1, wherein the value for the quartile deviation (QD) value for the grain size weight distribution of the phosphor constituting the phosphor layer is a value exceeding 0.25.

7. An imaging device according to claim 1, wherein the molar ratio of Si in the chemical formula of the phosphor is within the range from 0.8 to 1.2 based on the entire molar ratio.

8. An imaging device according to claim 1, wherein the phosphor is obtained by mixing a compound containing the constituent element other than the Si with a compound containing Si and heating and calcining them.

9. An imaging device according to claim 1, wherein the phosphor is obtained by heating and calcining a compound containing all of the constituents elements simultaneously.

10. An imaging device according to claim 1, wherein the range for the thickness of the phosphor layer is 0.5 μm or more and 40 μm or less.

11. An imaging device according to claim 1, wherein one or plural kinds of other phosphors is present together in the phosphor layer.

12. An imaging device according to claim 1, wherein electron beams are irradiated to the phosphor layer to emit a light.

13. An imaging device according to claim 1, wherein the imaging device is a projection type television set including a projection tube having a face plate formed with the phosphor layer, and an electron source for irradiating electron beams based on the image information to the phosphor layer to emit a light and a screen for displaying images projected from the projection tube.

14. An imaging device according to claim 1, wherein the imaging device includes a substrate formed with the phosphor layer, and a planer image display panel having an excitation unit for irradiating an excitation energy based on the image information to the phosphor layer to emit a light.

15. An imaging device according to claim 14, wherein the excitation unit for irradiating an excitation energy based on the image information to the phosphor layer to emit a light includes a field emission electron source being opposed to the phosphor layer formed to the substrate and unit for irradiating electron beams generated from the field emission electron source based on the image information as the excitation energy to the phosphor layer to emit light.

16. An imaging device according to claim 14, wherein the excitation unit for irradiating an excitation energy based on the image information to the phosphor layer to emit a light includes plasma generation unit containing a gas discharging electrode and a discharging rare gas, and includes unit for irradiating light generated by causing plasma discharge from the plasma generation unit based on the image information to the phosphor layer to emit a light.

17. A projection type color television set including three projection tubes for red signals, green signals, and blue signals having a face plate formed with a phosphor layer, and an electron source for irradiating electron beams based on image information to the phosphor layer to emit a light, and a screen for displaying images projected from the projection tubes, in which the phosphor layer formed to the face plate of the projection tube for green signals is a phosphor layer according to claims 1.

18. An imaging device including a light source having a phosphor layer and a liquid crystal panel in which the phosphor layer is a phosphor layer according to claim 1.

19. An imaging device according to claim 18, wherein the imaging device includes a white color emitting fluorescent lamp of a cold cathode ray tube structure having a phosphor layer containing a red color emitting phosphor, a green color emitting phosphor, and a blue color emitting phosphor as a light source, and a liquid crystal panel using the fluorescent lamp as a back light, and the phosphor layer is a phosphor layer according to claims 1.

20. A fluorescent lamp having a phosphor layer in which the phosphor layer is a phosphor layer according to claim 1.

21. A white light emitting fluorescent lamp of a cold cathode ray structure according to claim 19, wherein the fluorescent lamp has a phosphor layer containing a red color emitting phosphor, a green color emitting phosphor, and a blue color emitting phosphor.
